(19) United States
(12) Patent Application Publication
(10) Pub. No.: US 2009/0279534 A1
(43) Pub. Date: Nov. 12, 2009

(54) Method and System for Placing a VOIP Call

(75) Inventor: Eric REIHER, Longueuil (CA)

Correspondence Address: BENOIT & COTE, s.e.n.c., 1001, DE MAISONNEUVE BOULEVARD WEST, SUITE 210, MONTREAL, QC, H3A 3C8, CA

(73) Assignee: Mobivox Corporation, Montreal (CA)

(21) Appl. No.: 12/118,292

(22) Filed: May 9, 2008

(51) Int. Cl. H04L 12/66

(52) U.S. Cl. 370/352

(57) ABSTRACT

The present document describes a method and system for placing a VoIP call from a user using a user voice interface device in a given geographical area to a contact using a contact voice interface device in a distant geographical area. The method comprises: assigning an individual local access phone number per geographical area thereby resulting in a list of individual access phone numbers; the user placing a call from the user voice interface device to the individual local access phone number assigned to the given geographical area thereby initiating a first leg of the call from the user voice interface device to the bridge server through the PSTN; switching the call from the PSTN to a given URL which points to a bridge server accessible through the Internet; the user providing the identity of the contact to which the call must be completed, the identity of the contact corresponding to the contact voice interface to which a second leg of the call will be established; the bridge server establishing the second leg of the call from the bridge server to the contact voice interface device; and the bridge server bridging the first and second legs of the call thereby establishing the VoIP call from the user to the contact.

### CROSS-REFERENCE TO RELATED APPLICATIONS

This is the first application filed for the invention(s) described herein.

### TECHNICAL FIELD

This description relates to the field of telecommunications. More particularly, this description relates to placing calls between different geographical areas.

### BACKGROUND OF THE INVENTION

Users of voice communication devices and operators of voice networks wish to reduce or eliminate the cost of calls between different geographical areas. The emergence of the Voice-over-Internet-Protocol (VoIP) has greatly helped in this endeavor.

The present document describes improvements in voice call applications.

### SUMMARY OF THE INVENTION

According to an aspect of the invention, there is provided a method for placing a VoIP call from a user using a user voice interface device in a given geographical area to a contact using a contact voice interface device in a distant geographical area. The method comprises: assigning an individual local access phone number per geographical area; the user placing a call from the user voice interface device to the individual local access phone number assigned to the given geographical area thereby initiating a first leg of the call from the user voice interface device to the bridge server through the PSTN; switching the call from the PSTN to a given Uniform Resource Locator (URL) which points to a bridge server accessible through the Internet; the user providing the identity of the contact to which the call must be completed, the identity of the contact corresponding to the contact voice interface to which a second leg of the call will be established; the bridge server establishing the second leg of the call from the bridge server to the contact voice interface device; and the bridge server bridging the first and second legs of the call thereby establishing the VoIP call from the user to the contact.

According to another aspect of the invention, there is provided a system for placing a VoIP call from a user using a user voice interface device in a given geographical area to a contact using a contact voice interface device in a distant geographical area. The system comprises a plurality of PSTN-to-VoIP switches. Each switch is assigned an individual local access phone number according to the geographical area in which it is located. Each switch has: an input for receiving a call from the user through the PSTN, the user placing a call from the user voice interface device to the individual local access phone number assigned to the given geographical area thereby initiating a first leg of the call from the user voice interface device to a bridge server through the PSTN; and a mapping device for switching the call from the PSTN to a given URL, the given URL pointing to the bridge server accessible through the Internet. The system further comprises a bridge server which comprises an input for receiving, from the user through one of the PSTN-to-VoIP switches, the identity of the contact to which the call must be completed, the identity of the contact corresponding to the contact voice interface device to which a second leg of the call will be established; and an application server for establishing the second leg of the call from the bridge to the contact voice interface device and for bridging the first and second legs of the call thereby establishing the VoIP call from the user to the contact.

According to another aspect of the invention, there is provided a bridge server for completing a VoIP call from a user using a user voice interface device in a given geographical area to a contact using a contact voice interface device in a distant geographical area. The bridge server comprises: an input for receiving a call from at least one of a plurality of PSTN-to-VoIP switches, each switch being assigned a individual local access phone number according to the geographical area in which it is located, the user placing a call from the user voice interface device to the individual local access phone number assigned to the given geographical area thereby initiating a first leg of the call from the user voice interface device to the bridge server through the PSTN, the call being switched from the PSTN to a given URL, the given URL pointing to the bridge server accessible through the Internet, the input being further for receiving, from the user, the identity of the contact to which the call must be completed, the identity of the contact corresponding to the contact voice interface to which a second leg of the call will be established; and an application server for establishing the second leg of the call from the bridge to the contact voice interface device and for bridging the first and second legs of the call thereby establishing the VoIP call from the user to the contact.

According to another aspect of the invention, there is provided a method for placing a call from a user using a user voice interface device in a given geographical area to a contact using a contact voice interface device in a distant geographical area. The method comprises: assigning an individual local access phone number per geographical area; the user placing a call from the user voice interface device to the individual local access phone number assigned to the given geographical area thereby initiating a first leg of the call from the user voice interface device to the bridge server through the PSTN; switching the call from the PSTN to a bridge server; the user providing the identity of the contact to which the call must be completed, the identity of the contact corresponding to the contact voice interface to which a second leg of the call will be established; the bridge server establishing the second leg of the call from the bridge server to the contact voice interface device; and the bridge server bridging the first and second legs of the call thereby establishing the call from the user to the contact.

According to another aspect of the invention, there is provided a system for placing a call from a user using a user voice interface device in a given geographical area to a contact using a contact voice interface device in a distant geographical area. The system comprises a plurality of switches. Each switch is assigned an individual local access phone number according to the geographical area in which it is located. Each switch has: an input for receiving a call from the user through the PSTN, the user placing a call from the user voice interface device to the individual local access phone number assigned to the given geographical area thereby initiating a first leg of the call from the user voice interface device to a bridge server through the PSTN; and a mapping device for switching the call from the PSTN to the bridge server. The system further comprises a bridge server which comprises an input for receiving, from the user through one of the switches, the identity of the contact to which the call must be completed, the identity of the contact corresponding to the contact voice interface device to which a second leg of the call will be established; and an application server for establishing the second leg of the call from the bridge to the contact voice interface device and for bridging the first and second legs of the call thereby establishing the call from the user to the contact.

According to another aspect of the invention, there is provided a bridge server for completing a call from a user using a user voice interface device in a given geographical area to a contact using a contact voice interface device in a distant geographical area. The bridge server comprises: an input for receiving a call from at least one of a plurality of switches, each switch being assigned a individual local access phone number according to the geographical area in which it is located, the user placing a call from the user voice interface device to the individual local access phone number assigned to the given geographical area thereby initiating a first leg of the call from the user voice interface device to the bridge server through the PSTN, the call being switched from the PSTN the bridge server, the input being further for receiving, from the user, the identity of the contact to which the call must be completed, the identity of the contact corresponding to the contact voice interface to which a second leg of the call will be established; and an application server for establishing the second leg of the call from the bridge to the contact voice interface device and for bridging the first and second legs of the call thereby establishing the call from the user to the contact.

### BRIEF DESCRIPTION OF THE DRAWINGS

Further features and advantages of the present invention will become apparent from the following detailed description, taken in combination with the appended drawings, in which:

FIG. 1 is a block diagram illustrating an overview of the network in which are set and operated the system and method according to an embodiment of the present invention;

FIG. 2 is a block diagram showing a bridge server used for placing a VoIP call according to an embodiment of the invention;

FIG. 3 is a flowchart showing a method for placing a VoIP call according to an embodiment of the invention;

FIG. 4 is a block diagram of a PSTN-to-VoIP switch according to an embodiment of the invention; and

FIG. 5 is a flowchart showing a method for providing a service during a call according to an embodiment of the invention.

It will be noted that throughout the appended drawings, like features are identified by like reference numerals.

### DETAILED DESCRIPTION

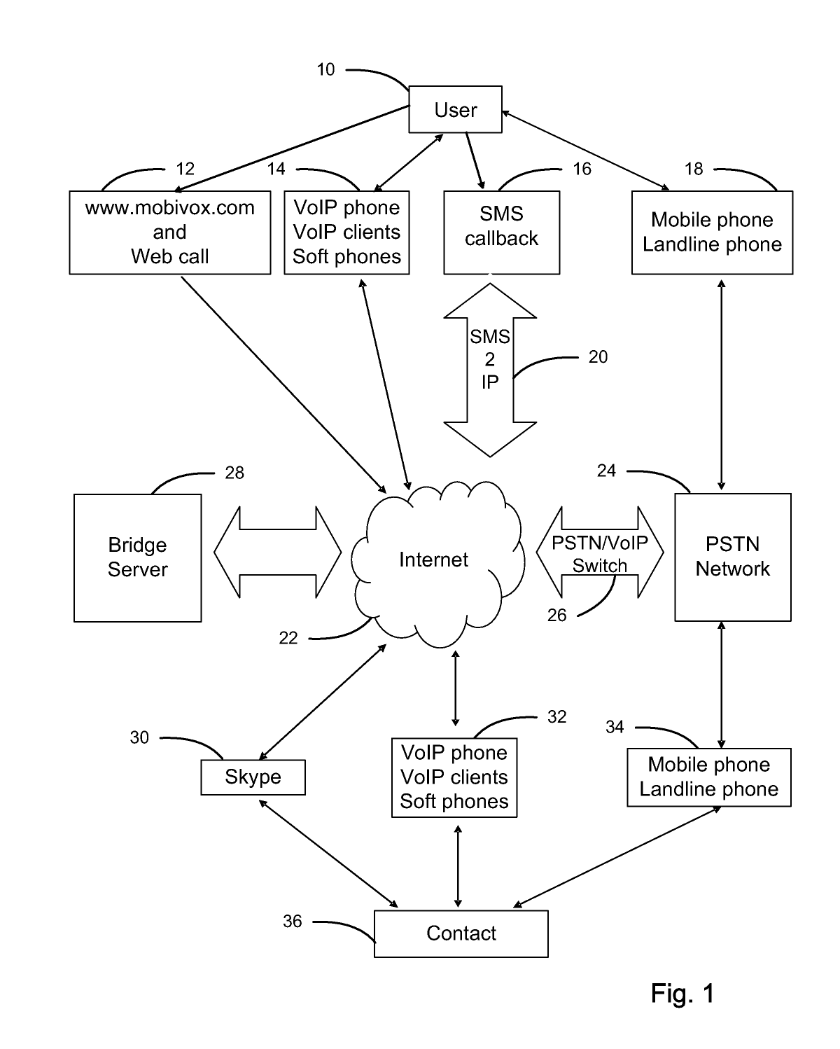

Referring now to the drawings, and more particularly to FIG. 1, a block diagram illustrates an overview of the network in which are set and operated the system and method according to an embodiment of the present invention.

More specifically, FIG. 1 shows a user 10 who wishes to place a VoIP call to a contact 36. It should be noted that the method and system described herein also cover the possibility for the user 10 to place a call to a plurality of contacts 36. To place a call, the user 10 may interact either with a Web interface 12, a VoIP device 14, an SMS (Short Message Service) device 16 or a conventional phone (mobile or landline) 18. VoIP device 14, conventional phone (mobile or landline) 18, satellite phones (not shown) constitute examples of voice interface devices.

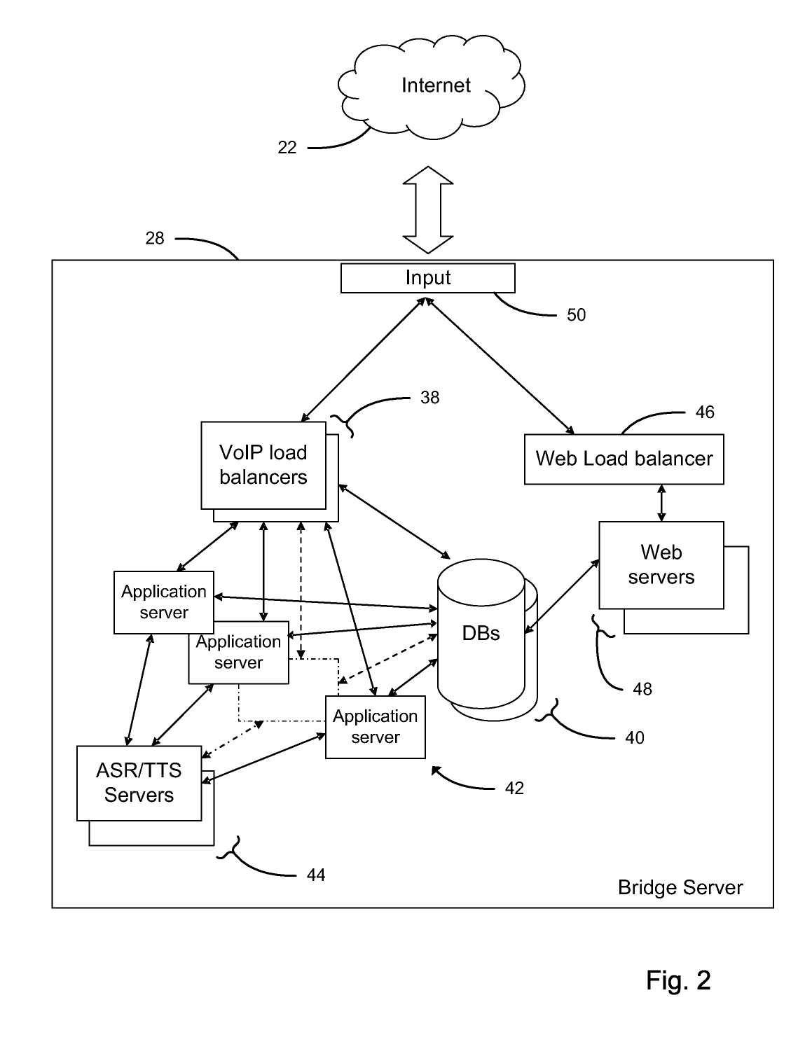

FIG. 1 further shows a bridge server 28 connected to the Internet 22. It should be noted that bridge server 28 comprises various services which includes a call assistant (not specifically shown on FIG. 2). Bridge server 28 will be discussed in more detail in conjunction with FIG. 2.

Returning to FIG. 1, in the case when a Web interface 12 or a VoIP device 14 is used to initiate a call, the user 10 is connected to the Internet 22. In the case when an SMS device 16 is used to initiate a call, an SMS-to-IP (Short Message Service to Internet Protocol) converter 20 is necessary to send a message to the Internet 22. The call will then be established through one of the voice interface devices shown in FIG. 1. In the case when a call is initiated through the Web or with an SMS, the user can specify in the message the name, phone number, short code, spell dial or speed dial of one or more contacts to reach. If contacts are specified, the call assistant will not ask any other information; she will place the call(s) directly.

In the case when a conventional phone 18 is used, the user is connected to the PSTN 24 by calling a local access phone number (also referred to in the art as a Direct Inward Dialing (DID) number, or Direct Dial-In (DDI) number in Europe. Only one phone number per geographical area is necessary for all users, as they will be identified when they call. A geographical area is defined as an area for which a call is local, i.e., it can be made by a user at a local call rate. A switch 26 then converts the call from the PSTN format to VoIP in order to interact with the Internet 22.

Finally, FIG. 1 shows a contact 36 and its possible means of connection to the Internet 22. That is, the connection between the contact 36 and the Internet 22 can be made through an interface 30 such as SKYPE, a VoIP device 32, or through a combination of a conventional phone (mobile or landline) 34, the PSTN 24 and switch 26.

Now referring to FIG. 2, there is shown a bridge server 28 according to an embodiment of the invention. The bridge server 28 includes one or more VoIP load balancers 38 connected to the input of bridge server 28. The VoIP load balancers 38 are connected to a plurality of application server 42 and to one or more databases 40. The application servers 42 are also connected to databases 40 and to ASR/TTS Servers 44 (ASR=Automated Speech Recognition, TTS=Text-to-Speech).

The application servers 42 may each include one or more specific applications. The applications include, but are not limited to, placing calls, accessing ASR/TTS applications on servers 44, accessing data on databases 40, performing a call-up function (through the use of a key pad on the user voice interface device), dynamic call conferencing, bridging contacts from different networks, dictating a message, group calling, transferring calls, etc.

The bridge server 28 also includes a Web load balancer 46 connected to the input of bridge server 28. Web load balancer 46 is used for Web connections. Web load balancer 46 is in turn connected to Web servers 48 which have access to databases 40. It is envisaged that there will be more than one bridge server 28; e.g., a bridge server per large geographical area of the globe.

A plurality of synchronized databases 40 having the same content would be required when there is a more than one database for the system; e.g., a database per large geographical area of the globe.

Now returning to FIG. 1, in operation, a user 10 has many alternatives for placing a VoIP call. The user 10 can access the operator's Web site 12 (i.e., www.mobivox.com in this example) and selects and logs in with his credentials to access a page of the Web site where his contacts are listed. The user 10 then selects a contact 36 to whom a call must be placed and a voice interface device from which the call must be placed. This information is provided to the Web load balancer 46 (see FIG. 2) of bridge server 28 through the Internet 22. The Web load balancer 46 then selects a Web server 48 that may service the call. The Web server may then access database 40 so that when a user logs into his account on the web, he has access to all his information: user profile, account info, call history, credits in his account, access numbers, rates, user status, etc. The selected Web server 48 then places a call (first leg) to the voice interface device selected by the user 10. When the user 10 picks up, the selected Web server 48 places a call (second leg) to the voice interface device of the contact 36 selected by the user and bridges the first and second legs of the call.

According to another example, the user places a call to a contact using a VoIP device 14 such as a VoIP phone, a VoIP client or a Soft Phone. The user 10 specifies the contact 36 to which a calls must be placed. The VoIP device 14 accesses bridge server 28 which accesses one of the Web servers 48. The first leg of the call is completed. The Web server 38 accesses the database 40 to check the user account information: user profile, account info, call history, credits in his account, access numbers, rates, user status, etc The selected Web server 48 places a call (second leg) to the voice interface device of the contact 36 selected by the user 10 and bridges the first and second legs of the call.

According to another example, the user 10 sends an SMS message to a specified number using a mobile phone, a landline phone, a satellite phone or any other SMS-enabled device. The SMS message contains at least information concerning to which voice interface device the bridge server 28 should place the first leg of the call and to which voice interface device the bridge server 28 should place the second leg of the call. The SMS message may therefore include one or more names, one or more phone numbers, one or more IP address, and/or one or more identity of a contact, user or device associated thereto. The selected Web server 48 of bridge server 28 then places a call (first leg) to the voice interface device selected by the user 10. When the user 10 picks up, the selected Web server 48 places a call (second leg) to the voice interface device of the contact 36 selected by the user and bridges the first and second legs of the call.

According to another example, the user 10 uses a conventional phone (landline or mobile) 18 to call the local number in his geographical area. The local number is determined by the operator of the voice telephony network. The conventional phone 18 may be pre-registered in the database 40 of bridge 40 or not. The CLID (Calling Line Identification) will be passed on to and used by the bridge 40 to determine pre-registration or not. When the conventional phone being used is not pre-registered, the user will eventually be prompted to provide his identity. The conventional phone 18 connects to the PSTN 24 which will connect to the Internet 22 through PSTN/VoIP switch 26. The first leg of the call is then completed to bridge server 28.

As shown in FIG. 2, upon receipt of a call, one of the VoIP load balancers 38 comes into actions. The selected VoIP load balancer 38 will determine which one of the application servers 42 is available to service the call. The selected application server 42 will prompt the user to state the name of the contact to which the call should be placed. This will cause the application server 42 to request the services of the ASR/TTS server 44 to recognize the contact's stated name. User 10 can also specify the identity of a contact 36 either by dialing his phone number, saying his name or dialing a speed dial, short code, spell dialing or any other unique way of identifying his contact. Once the name of the contact 36 is ascertained, the selected application server 42 places a call to the selected contact 36 to complete the second leg of the call and to bridge the first and second legs to complete the call.

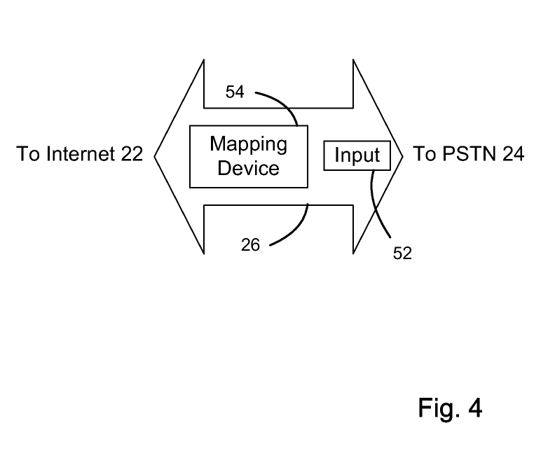

Now turning to FIG. 4, there shown the PSTN-to-VoIP switch in further detail. The PSTN-to-VoIP switch 26 comprises in input 52 for receiving a call from the user 10 through the PSTN 24. The PSTN-to-VoIP switch 26 further comprises a mapping device 54 for switching the call from the PSTN 24 to a given URL. The given URL pointing to the bridge server 28 through the Internet 22.

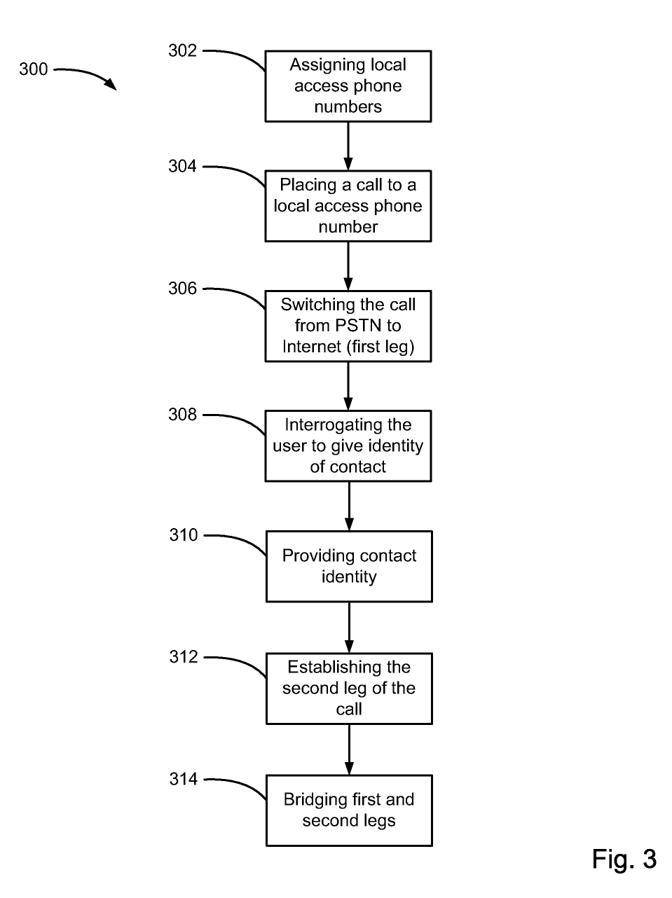

Now turning to FIG. 3, there is described a method 300 for placing a VoIP call from a user using a user voice interface device in a given geographical area to a contact using a contact voice interface device in a distant geographical area. Method 300 comprises the following steps. In step 302, an individual local access phone number per geographical area is assigned thereby resulting in a list of individual access phone numbers. The user then places a call (step 304) from the user voice interface device to the individual local access phone number assigned to the given geographical area thereby initiating a first leg of the call from the user voice interface device to the bridge server through the PSTN. In an embodiment, the call comprises caller identification information identifying the user voice interface device from which the call originates. In the next step (step 306), the call is switched from the PSTN to a given URL. The given URL pointing to a bridge server accessible through the Internet. The bridge server then interrogates, at step 308, the user identified from the caller identification information to provide an identity of the contact to which a second leg of the call will be established. The user then provides the identity of the contact to which the call must be completed (step 310). The bridge establishes the second leg of the call from the bridge to the contact voice interface device (step 312). Finally, the bridge bridges the first and second legs of the call thereby establishing the VoIP call from the user to the contact (step 314).

It will be useful for the user 10 to register the identity (e.g., names and corresponding phone numbers) of his contacts with the voice call operator. In this example, the voice call operator is the same as the bridge operator. When prompted to provide the identity of the contact to which the call must be completed, user 10 then simply states the name of the contact and the ASR application server 44 processes the speech so that the selected application server 42 can complete the second leg of the call.

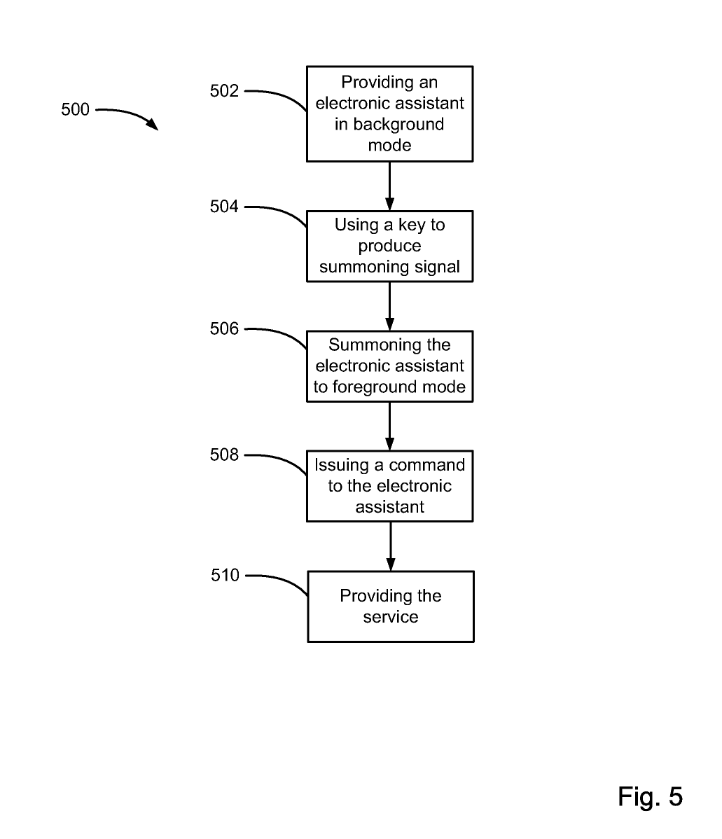

Now turning to FIG. 5, there is described an embodiment of a method 500 for providing a service during a call established between a user making the call and a contact. The call is established using a voice interface device having a key. Method 500 comprises, at step 502, providing an electronic assistant in a background mode and, at step 504, using the key to produce a summoning signal.

According to an embodiment, the call is a VoIP call established through a bridge server as described herein.

According to an embodiment, the key forms part of a Dual-Tone Multi-Frequency (DTMF) keypad, and using the key comprises using at least one of depressing a star key (*) on the DTMF keypad, depressing a star key (*) twice, and depressing a combination of keys on the DTMF keypad. There can be a time delay imposed for depressing the DTMF keys. This is useful in situations when a user is depressing DTMF keys for interacting with other in-band devices or applications.

According to another embodiment, the key forms part of at least one of a keypad, a touch-screen device, and a mouse on the user interface device, and using the key comprises using the at least one of a keypad, a touch-screen device, and a mouse.

According to an embodiment using the key to produce a summoning command is available only to the user making the call. In such a case, the electronic assistant is in communication only with the user making the call.

Now returning to FIG. 5, method 500 further comprises step 506 which, upon detection of the summoning signal, summons the electronic assistant to a foreground mode. Next, at step 508, a command is issued to the electronic assistant for the provision of a service. Finally, at step 510, the service is provided upon detection of the command.

According to an embodiment, the electronic assistant may be returned to the background mode at any time during the execution of method 500. The same or a different key or combination of keys as described above may be used to return the electronic assistant to the background mode.

According to an embodiment, the issuing of a command to the electronic assistant comprises an in-band signal thereby defining an in-band command signal. The in-band command signal comprises at least one of a voice signal and a DTMF signal. The DTMF signal may include a combination of keys depressed on a keypad. When the in-band command signal comprises a voice signal, method 500 further comprises performing speech recognition of the voice signal to resolve the command to the electronic assistant. In an embodiment, the speech recognition is performed by the ASR/TTS server.

According to an embodiment, the provision of a service by the electronic assistant comprises at least one of performing a call-up function, dynamic call conferencing, bridging contacts from different networks (or within the same network), dictating a message or a correspondence, group calling, transferring a call, recording a call, terminating a call, finding information in an internal or external database, adding information to an internal or external database, searching the Web, and consulting a schedule or calendar.

It should be noted that the method and systems described herein are equally applicable to all types of calls such as PSTN, cellular and VoIP calls.

The embodiments of the invention described above are intended to be exemplary only. The scope of the invention is therefore intended to be limited solely by the scope of the appended claims.

1. A method for placing a VoIP call from a user using a user voice interface device in a given geographical area to a contact using a contact voice interface device in a distant geographical area, the method comprising:
assigning an individual local access phone number per geographical area;
the user placing a call from the user voice interface device to the individual local access phone number assigned to the given geographical area thereby initiating a first leg of the call from the user voice interface device to the bridge server through the PSTN;
switching the call from the PSTN to a given URL which points to a bridge server accessible through the Internet;
the user providing the identity of the contact to which the call must be completed, the identity of the contact corresponding to the contact voice interface to which a second leg of the call will be established;
the bridge server establishing the second leg of the call from the bridge server to the contact voice interface device; and
the bridge server bridging the first and second legs of the call thereby establishing the VoIP call from the user to the contact.

2. The method of claim 1, further comprising the user the entering contact information for his contacts prior to placing a call thereby creating a contact list for the user.

3. The method of claim 1, further comprising the user voice interface device providing caller identification information, wherein the caller identification information comprises at least one of a caller ID, a calling line ID, a calling number identification, a user entered phone number and an IP address of the user voice interface device, the provided caller identification information for identifying the user voice interface device.

4. The method of claim 3, further comprising accessing a database to determine if the identified user voice interface device is registered in the database and to which user the user voice interface device is registered.

5. The method of claim 4, wherein upon determination that the identified user voice interface device is registered, interrogating the user to provide the identity of the contact corresponding to the contact voice interface device to which the call must be completed.

6. The method of claim 4, wherein upon determination that the identified user voice interface is not registered, prompting the user to enter a Personal Identification Number (PIN).

7. The method of claim 6, further comprising using the PIN to determine if the user is registered and upon positive determination that the user is registered, interrogating the user to provide the identity of the contact corresponding to the contact voice interface device to which the call must be completed.

8. A system for placing a VoIP call from a user using a user voice interface device in a given geographical area to a contact using a contact voice interface device in a distant geographical area, the system comprising:
a plurality of PSTN-to-VoIP switches, each switch being assigned an individual local access phone number according to the geographical area in which it is located, each switch having:
an input for receiving a call from the user through the PSTN, the user placing a call from the user voice interface device to the individual local access phone number assigned to the given geographical area thereby initiating a first leg of the call from the user voice interface device to a bridge server through the PSTN; and
a mapping device for switching the call from the PSTN to a given URL, the given URL pointing to the bridge server accessible through the Internet; and
the bridge server comprising:
an input for receiving, from the user through one of the PSTN-to-VoIP switches, the identity of the contact to which the call must be completed, the identity of the contact corresponding to the contact voice interface device to which a second leg of the call will be established; and
an application server for establishing the second leg of the call from the bridge to the contact voice interface device and for bridging the first and second legs of the call thereby establishing the VoIP call from the user to the contact.

9. The system of claim 8, wherein the bridge server further comprises a database for the user to enter contact information for his contacts prior to placing a call thereby creating a contact list for the user

10. The system of claim 8, wherein the input of the bridge server is further for receiving caller identification information for identifying the user voice interface device.

11. The system of claim 10, wherein the bridge server further comprises a database to determine if the identified user voice interface device is registered in the database and to which user the user voice interface device is registered.

12. The system of claim 11, wherein the bridge server further comprises an ASR/TTS server which, upon determination that the identified user voice interface device is registered, is for interrogating the user to provide the identity of the contact corresponding to the contact voice interface device to which the call must be completed.

13. The system of claim 11, wherein the bridge server further comprises an ASR/TTS server which, upon determination that the identified user voice interface device is not registered, is for prompting the user to enter at least one of a phone number and a Personal Identification Number (PIN).

14. The system of claim 13, wherein the database is further for using the at least one of a phone number and the PIN to determine if the user is registered and upon positive determination that the user is registered, interrogating the user to provide the identity of the contact corresponding to the contact voice interface device to which the call must be completed.

15. A bridge server for completing a VoIP call from a user using a user voice interface device in a given geographical area to a contact using a contact voice interface device in a distant geographical area, the bridge server comprising:
an input for receiving a call from at least one of a plurality of PSTN-to-VoIP switches, each switch being assigned a individual local access phone number according to the geographical area in which it is located, the user placing a call from the user voice interface device to the individual local access phone number assigned to the given geographical area thereby initiating a first leg of the call from the user voice interface device to the bridge server through the PSTN, the call being switched from the PSTN to a given URL, the given URL pointing to the bridge server accessible through the Internet, the input being further for receiving, from the user, the identity of the contact to which the call must be completed, the identity of the contact corresponding to the contact voice interface to which a second leg of the call will be established; and
an application server for establishing the second leg of the call from the bridge to the contact voice interface device and for bridging the first and second legs of the call thereby establishing the VoIP call from the user to the contact.

16. The bridge server of claim 15, further comprising a database for the user to enter contact information for his contacts prior to placing a call thereby creating a contact list for the user

17. The bridge server of claim 15, wherein the input of the bridge server is further for receiving caller identification information for identifying the user voice interface device.

18. The bridge server of claim 17, further comprising a database to determine if the identified user voice interface device is registered in the database and to which user the user voice interface device is registered.

19. The bridge server of claim 18, further comprising an ASR/TTS server which, upon determination that the identified user voice interface device is registered, is for interrogating the user to provide the identity of the contact corresponding to the contact voice interface device to which the call must be completed.

20. The system of claim 19, further comprising an ASR/TTS server which, upon determination that the identified user voice interface device is not registered, is for prompting the user to enter at least one of a phone number and a Personal Identification Number (PIN).

21. The bridge server of claim 20, wherein the database is further for using the at least one of a phone number and the PIN to determine if the user is registered and upon positive determination that the user is registered, interrogating the user to provide the identity of the contact corresponding to the contact voice interface device to which the call must be completed.
